(19) United States
(12) Patent Application Publication
(10) Pub. No.: US 2005/0116935 A1
(43) Pub. Date: Jun. 2, 2005

(54) Method and system for use of a handheld trackball to control an imaging system

(76) Inventor: Michael Joseph Washburn, Brookfield, WI (US)

Correspondence Address: MCANDREWS HELD & MALLOY, LTD, 500 WEST MADISON STREET, SUITE 3400, CHICAGO, IL, 60661, US

(21) Appl. No.: 10/725,802

(22) Filed: Dec. 2, 2003

(51) Int. Cl. G09G 5/08

(52) U.S. Cl. 345/167

(57) ABSTRACT

Certain embodiments of the present invention provide a method and system for remote operation of an imaging system. The method includes moving a trackball in a handheld trackball device, transmitting a command based on movement of the trackball to an imaging system, and adjusting a setting or function of the imaging system based on the command. The handheld trackball device includes a trackball for controlling an imaging system based on motion of the trackball, a transmitter for transmitting a command to the imaging system based on motion of the trackball, and a housing for holding the trackball and the transmitter. The device may also include one or more buttons for controlling one or more imaging system functions. The trackball device may work with a voice command, a foot switch, and/or a remote keypad to control the imaging system. The trackball device may also be integrated with an instrument.

### BACKGROUND OF THE INVENTION

The present invention generally relates to control of an imaging system. In particular, the present invention relates to a use of handheld mouse or trackball for control of an imaging system.

Imaging systems encompass a variety of imaging modalities, such as x-ray systems, computerized tomography (CT) systems, ultrasound systems, electron beam tomography (EBT) systems, magnetic resonance (MR) systems, and the like. Imaging systems generate images of an object, such as a patient, for example, through exposure to an energy source or wave, such as ultrasound beams traveling into a patient and producing echo signals reflected from bone and tissue inside the patient, for example. The generated images may be used for many purposes. For instance, internal defects in an object may be detected. Additionally, changes in internal structure or alignment may be determined. Fluid flow within an object may also be represented. Furthermore, the image may show the presence or absence of structures in an object.

The information gained from medical diagnostic imaging has applications in many fields, including medicine, manufacturing, and security. For example, imaging systems may be used for medical diagnosis and surgical navigation. Additionally, imaging systems may be used for safety and security applications, for example. Imaging systems may be used to help determine structural integrity of components as well.

Imaging systems are complicated to configure and to operate. Additionally, use of imaging systems involves training and preparation that may vary from user to user. Thus, a system and method that facilitate operation of an imaging system would be highly desirable. An operator of an ultrasound imaging system, for example, must configure and control the ultrasound system at a console while moving a transducer over an area of interest to obtain ultrasound image data. Therefore, a need exists for a system and method that improve ease of use and automation of an imaging system.

In many situations, an operator of an imaging system may experience difficulty when scanning a patient or other object using the imaging system console. For example, using an imaging system, such as an ultrasound imaging system, for upper and lower extremity exams, compression exams, carotid exams, neo-natal head exams, and portable exams may be difficult with a typical system control console. An operator may not be able to physically reach both the console and a location to be scanned. Additionally, an operator may not be able to adjust a patient being scanned and operate the system at the console simultaneously. Providing an additional operator or assistant to assist with examination may increase cost of the examination and may produce errors or unusable data due to miscommunication between the operator and the assistant. Thus, a method and system that facilitates operation of an imaging system by an operator would be highly desirable.

In an ultrasound system, for example, one hand of a user controls a transducer scanning a patient, and another hand drives controls of the ultrasound system. Often, scanning conditions force a user to move far away from an operating console of the ultrasound system. If a user moves away from the console, controls are difficult to access.

Footswitches or remote keypads have been used to allow limited control of an imaging system, such as an ultrasound system, while at a distance from the console. Limited voice control has also been used to convey a limited set of commands to the ultrasound system. However, current methods of remote control, such as footswitches, remote keypads, or voice control, are limited in types or degrees of control over the imaging system. Remote keypads must be held or placed somewhere. Often, it is not feasible to rest a remote keypad on a patient or on a floor during examination. Keypads also offer certain preset buttons but not flexible control, selection, or movement, for example. Footswitches typically support up to three commands. Such a limited command set is typically insufficient for most exams. Current voice control does not allow for fine adjustments or manipulation of imaging control. An imaging system must be configured to recognize certain set commands from voice control. Thus, there is a need for a system and method that provide remote imaging system control not found in current remote control systems.

Therefore, an improved system and method for controlling an imaging system would be highly desirable.

### BRIEF SUMMARY OF THE INVENTION

Certain embodiments of the present invention provide a method and system for remote operation of an imaging system. In an embodiment, the method includes moving a trackball in a handheld trackball device, transmitting a command based on movement of the trackball to an imaging system from the handheld trackball device, and adjusting a setting or function of the imaging system based on the command. Transmission of command(s) may include wired or wireless transmission. Moving may include rolling and/or clicking the trackball. In an embodiment, the trackball is a wheel on a mousing device.

In an embodiment, the imaging system may also be controlled using voice commands. The imaging system may also be controlled using a foot switch and/or a remote keypad. Pressing a button on the handheld trackball device may also trigger an imaging system command.

Certain embodiments provide a handheld trackball device for controlling an imaging system. The device includes a trackball for controlling an imaging system based on motion of the trackball, a transmitter for transmitting a command to the imaging system based on motion of the trackball, and a housing for holding the trackball and the transmitter. The device may also include one or more buttons for controlling one or more imaging system functions. The trackball device may work with a voice command, a foot switch, and/or a remote keypad to control the imaging system. In an embodiment, the trackball includes a wheel on a mousing device. The handheld trackball device may be a wired or wireless handheld trackball device.

Certain embodiments provide a remote mousing device for operating an imaging system. The mousing device includes a moveable portion for operating an imaging system based on motion of the moveable portion and a transmitter for transmitting a command to the imaging system based on the moveable portion. The moveable portion may include a trackball, a wheel, and/or a joystick, for example. The mousing device may also include an additional input receptor. The additional input receptor may include a button, a switch, and/or a touch screen, for example. In an embodiment, the mousing device works with at least one of a voice command, a foot switch, and a remote keypad to control the imaging system. In an embodiment, the mousing device is a wireless mousing device. In an embodiment, the mousing device is a handheld mousing device. The mousing device may also include a fastener for affixing the mousing device to an operator and/or a subject being imaged. In an embodiment, the mousing device may be integrated with an instrument, such as an ultrasound transducer probe or other medical or imaging instrument.

### BRIEF DESCRIPTION OF SEVERAL VIEWS OF THE DRAWINGS

FIG. 1 illustrates a block diagram of an ultrasound imaging system used in accordance with an embodiment of the present invention.

FIG. 2 illustrates a flow diagram for a method for ultrasound imaging in accordance with an embodiment of the present invention.

FIG. 3 depicts an example of a handheld trackball device used in accordance with an embodiment of the present invention.

FIG. 4 illustrates a flow diagram for a method for controlling an imaging system used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide a control and interface system and method that may be used with a variety of imaging systems. For purposes of illustration only, certain embodiments will be described in relation to an ultrasound imaging system.

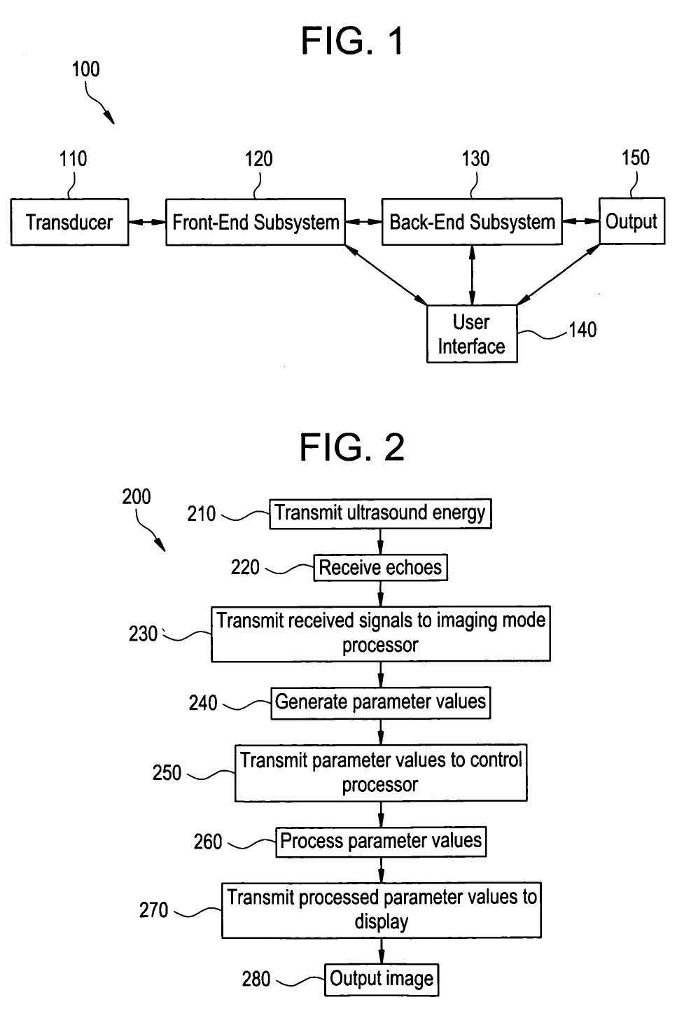

FIG. 1 illustrates a block diagram of an ultrasound imaging system 100 used in accordance with an embodiment of the present invention. The system 100 includes a transducer 110, a front-end subsystem 120, a back-end subsystem 130, a user interface 140, and an output 150. The back-end subsystem may include one or more imaging mode processors, such as a Doppler processor and/or a non-Doppler processor, and a control processor, for example. The front-end subsystem 120 may include a receiver, a transmitter, and one or more beamformers, for example.

The transducer 110 is used to transmit ultrasound waves into a subject by converting electrical analog signals to ultrasonic energy. The transducer 110 also is used to receive ultrasound waves that are backscattered from the subject by converting ultrasonic energy to electrical signals.

The front-end subsystem 120 is used to create transmitted waveforms, beam patterns, receiver filtering techniques, and demodulation schemes that are used for various imaging modes. The front-end subsystem 120 converts digital data to analog data and vice versa. The front-end subsystem 120 interfaces with the transducer 110 to transmit ultrasound beams and receive reflected echo signals. The front-end subsystem 120 interfaces with the back-end subsystem 130.

The processor(s) of the back-end subsystem 130 provide amplitude detection, data compression, and other processing for an imaging mode, such as B-mode imaging, M-mode imaging, BM-mode imaging, harmonic imaging, Doppler imaging, color flow imaging, and/or any other ultrasound imaging mode. The back-end subsystem 130 receives digital signal data from the front-end subsystem 120. The back-end subsystem 130 processes the received digital signal data to produce image data values. The image data values may be produced using the received digital signal data. The digital signal data may be analyzed in frequency bands centered at the fundamental, harmonics, and/or sub-harmonics, for example, of the transmitted signals to produce the image data values.

The digital image data values may then be processed using scan conversion functions, color mapping functions, compounding functions, and/or tissue/flow arbitration functions, for example. The back-end subsystem 130 processes, maps, and formats the digital image data and transmits image data to the output 150. The output 150 may display, store, and/or transmit the image data.

The user interface 140 allows user commands and/or configuration information to be input by the operator to the ultrasound imaging system 100. The user interface 140 may include a keyboard, touch pad, mouse, switches, knobs, buttons, track ball, foot switches, and/or on screen menus, for example. In an embodiment, the user interface 140 may run on a computer and interface with the back-end subsystem 130 and/or the front-end subsystem 120. The back-end subsystem 130, the front-end subsystem 120, and/or the output 150 may also be implemented on a computer. An operator may configure and control the imaging system 100 via the user interface 140. For example, an operator may position a scan, set up imaging parameters, select an imaging mode, and/or process resulting image data using the user interface 140. In an alternative embodiment, the user interface 140 may be programmed to automatically execute defined imaging routines.

FIG. 2 illustrates a method 200 for ultrasound imaging in accordance with an embodiment of the present invention. First, at step 210, an ultrasound beam is formed according to parameters, such as imaging mode and steering angle. Next, at step 220, the transducer 110 transmits ultrasound energy into a subject, such as a patient. Then, at step 230, ultrasound energy or echoes backscattered from the subject are received at the transducer 110. Signals are received at the front-end subsystem 120 in response to ultrasound waves backscattered from the subject.

Next, at step 240, the received signals are transmitted from the front-end subsystem 120 to the back-end subsystem 130. At step 250, the back-end subsystem 130 generates image data values based on the received signals. At step 260, the image data values are processed for use in display, storage, transmission, and diagnostics at the output 150.

Next, at step 270, processed image data values are transmitted to the output 150. Finally, at step 280, a diagnostic image is produced and output at the output 150. The image may be stored, displayed, printed, and/or further transmitted, for example. The output 150 may produce the diagnostic image using the processed digital signal data.

The user interface 140 may be used with the system 100 to execute an ultrasound imaging scan and configure system and imaging parameters. For example, an operator may select options from on-screen menus, such as a Microsoft Windows-based pull-down windows system. Alternatively, the user interface 140 may include a touch pad. A touch panel may be used to trigger and configure system 100 functions. In another embodiment, the user interface 140 may be a display including on-screen buttons clicked by a mouse, trackball, or other pointing device.

In an embodiment, remote control units may be used in conjunction with the user interface 140 to control the system 100 from various points in an examination room. Footswitches may be programmed to transmit a few commands in the system 100. Remote keypads may also be programmed to trigger a few commands or enter certain information in the system 100. Voice commands may provide an operator with an ability to verbally depress some keys of a control keypad or execute basic system commands. For example, a user may be able to set a mode or other basic parameters and may be able to freeze and print/store an image. However, footswitches, remote keypads, and voice commands do not allow adjustments such as adjustment of a Doppler range gate position, for example. Such functions and fine adjustments are typically performed using a trackball or equivalent mouse device on the user interface 140 console.

A mousing device, such as a trackball, may be used to position a Doppler range gate (a location on a vessel where quantitative Doppler information is to be obtained), measuring or tracing an anatomy, and other high-use and important controls. Many features controlled by the trackball or other mousing device are frequently adjusted or repositioned during imaging. With a trackball or similar device, scanning may be stopped, and the trackball may be used to move between image frames to locate a desired image. Additionally, motion of images on a display may be driven using a trackball. A quantity/speed of motion in scanned images or imaging may be based on trackball movement.

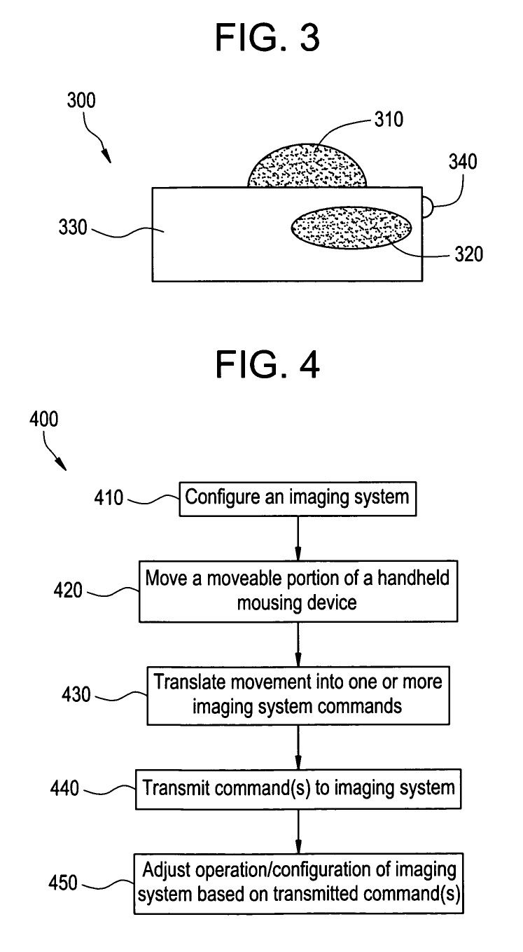

FIG. 3 depicts an example of a handheld trackball device 300 used in accordance with an embodiment of the present invention. The portable trackball 300 may be wireless or may be connected to the user interface 140 via a wire. A wireless trackball 300 may communicate via wireless radio frequency (RF) transmission, microwave transmission, infrared transmission, or other frequency transmission, for example. The trackball device 300 includes a trackball 310, one or more buttons 320, a housing 330, and a transceiver 340. The trackball device 300 may be ergonomically designed to fit comfortably in a hand of an operator. Fingers may be used to operate the trackball 310 and the button(s) 320.

In an embodiment, the trackball 310 is a solid ball that revolves freely in a socket in the housing 330. Electronics (not shown) in the housing 330 translate movement of the trackball 310 into imaging motion in the system 100, commands, and/or movement on the output 150 or user interface 140. The transceiver 340 communicates with the user interface 140 to relay commands/movement between the trackball 310 and the system 100. Button(s) 320 in the housing 330 may be programmed to trigger certain commands and/or functions in the system 100. Button presses may also be communicated to the user interface 140 using the transceiver 340. In an embodiment, the system 100 may also send feedback to the trackball device 300 using the transceiver 340.

The handheld trackball 300 or mousing device may be held by an operator and manipulated without having to rest the device on a surface, as an operator must do with a keypad or footswitch. System 100 controls typically driven by a mouse or trackball on the user interface 140 console may be available at a distance and remotely driven. The device 300 may have other controls, such as button(s) 320, to allow common system commands, such as freezing and printing/storing an image, to be remotely triggered. Additionally, the trackball 310 may be pressed to trigger a system command. A wireless handheld mouse or trackball device 300 eliminates wires, which may become tangled with equipment or a patient.

In an embodiment, buttons 320 on the trackball device 300 are equivalent to left and right mouse buttons. Pressing the button(s) 320 triggers an event in the system 100. A response at the system 100 may be dependent upon a location of a pointer on the user interface 140 screen. For example, if the pointer, such as a mouse pointer, is positioned over a certain button on the user interface 140 screen, clicking the button 320 causes the button on the user interface 140 screen to be pressed. If the pointer is positioned on a corner of a window at the user interface 140, clicking the button 320 causes the window to be closed. Thus, using the trackball 310 and button(s) 320, a user may control a wide variety of system 100 functions. In an embodiment, a left button triggers an action based on a position of a pointer on the user interface 140, and a right button allows an operator to open a menu of choices on the user interface 140 based on location of the pointer. In an embodiment, additional functionality may be assigned to double-clicking the button 320. Pressing the button(s) 320 may also be used to select options on a touch pad user interface 140.

In an embodiment, the device 300 may be combined with voice control of an imaging system. The handheld device 300 controls console actions involving a mouse or trackball. Voice control executes commands typically driven by other controls, such as physical or on-screen buttons, rotaries, and/or paddle switches. A wireless or wired microphone may be attached to a patient or object being scanned or may be attached to an operator, for example. The device 300 may be held in one hand of the operator or may be affixed to the patient/object or operator (e.g., clipped to clothing) by a fastener, for example. Thus, control of the system 100 does not depend on location of patient/object, system 100, or other equipment. The handheld device 300 may be ergonomically designed to fit in a hand in a proper shape, and voice commands do not strain or inconvenience an operator.

In operation, the handheld trackball device 300 may be used to control the system 100. For example, a patient may be positioned on a table in an examination room with an ultrasound system 100. A physician may configure basic settings and operational mode at the user interface 140 console. Then, the physician may position the transducer 110 on the patient such that ultrasound beams may be formed in the front-end subsystem 120 and transmitted into the patient through the transducer 110.

As the physician moves the transducer 110 over the patient to obtain an ultrasound image, the physician moves away from the user interface 140 console. The physician may use voice commands to enable (“Doppler on”) and disable (“Doppler off”) Doppler imaging. While one hand of the physician moves the transducer 110, the other hand holds the trackball device 300. A thumb or other finger of the physician's hand may move the trackball 310 to position a Doppler range gate over a blood vessel location where Doppler information is to be obtained. When Doppler images of a desired location have been obtained, the physician may use the button 320 to freeze the images. The trackball 310 may be used to scroll through image frames to locate a desired image. A voice command (“Print frame”) may then be used to print the image frame for further examination.

Another mousing device, such as a mouse with scrolling wheel, a touch pad, a joystick, or other device, may be used with the system 100 in place of the trackball device 300. In an embodiment, any device with a moveable portion, such as a ball, wheel, or other roller, may be used to send commands to an imaging system via a transmitter and/or a receiver. Additional input receptor(s), such as a button, switch, and/or touch screen, may also be added to the device to trigger additional functions in the imaging system. A processor and/or sensor may convert motion of the moveable portion and/or input receptor(s) into commands from the imaging system. A transmitter or transceiver transmits the commands to the imaging system. A receiver or transceiver may receive feedback from the imaging system. The mousing device may also include a fastener, such as a clip, pin, or Velcro, to affix the mousing device to the operator or to the subject being imaged.

In an embodiment, the mousing device, such as a trackball device or mouse, may be integrated with an instrument, such as an ultrasound transducer probe. Integrating a mousing device with an imaging or medical instrument allows an operator to access and control functions/settings of an imaging system while obtaining an imaging of an object or performing a procedure. For example, a trackball and buttons may be added to an ultrasound transducer probe to allow an operator to control an ultrasound system and trigger commands while moving the transducer over a patient to obtain an ultrasound image. A mousing device may be added to a catheter control or surgical navigation device, for example, to allow a doctor to adjust imaging settings during a medical procedure.

FIG. 4 illustrates a flow diagram for a method 400 for controlling an imaging system used in accordance with an embodiment of the present invention. First, at step 410, an imaging system is configured for imaging. For example, an operator may set up the imaging system for an imaging mode. A patient may be positioned with respect to the imaging system or imaging apparatus (a transducer or x-ray source/detector, for example).

Then, at step 420, a moveable portion of a handheld mousing device may be moved by an operator. For example, a trackball, wheel, or other rolling device may be moved by a finger of an operator to control the imaging system. Next, at step 430, movement of the moveable portion is translated into one or more commands for the imaging system. For example, rolling the trackball to the right is translated into an imaging scrolling command for the imaging system. A click of the trackball or a button may translate into a freeze command for the imaging system.

At step 440, command(s) generated from the moveable portion are transmitted to the imaging system. For example, a transmitter or transceiver on the handheld mousing device transmit the commands to the imaging system 100 to control operation or configuration of the imaging system. Transmission may be wired or wireless transmission. Then, at step 450, an operation and/or setting of the imaging system is adjusted based on the command(s) from the handheld device. For example, a Doppler range gate may be set for ultrasound imaging based on the transmitted command. Remote control of the imaging system using the mousing device may continue as the operator scans an object to be imaged.

The handheld mousing device allows an operator to image an object without being tethered to the user interface 140 console. The mousing device may be handheld and/or affixed to the operator or object. In an embodiment, a voice command, a foot switch, and/or a remote keypad may be used to control the imaging system in conjunction with the remote handheld mousing device.

Thus, certain embodiments provide a handheld trackball device that provides ergonomic ease of use for operating an imaging system at a distance. Certain embodiments allow better use of an operator's hands and provide less clutter for an examination environment. Certain embodiments provide increased operator comfort. For example, an operator may rest his or her hand at his or her side or lap rather than extending an arm to perform a control function. Certain embodiments combine a wireless handheld trackball device with voice command for improved system control and flexible use. Certain embodiments may be used to control a variety of imaging systems for a variety of applications.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for remotely operating an imaging system, said method comprising:
moving a trackball in a handheld trackball device;
transmitting a command based on movement of said trackball to an imaging system from said handheld trackball device; and
adjusting a setting or function of said imaging system based on said command.

2. The method of claim 1, wherein said transmitting step further comprises wireless transmission of said command to said imaging system.

3. The method of claim 1, wherein said moving step further comprises at least one of rolling and clicking said trackball.

4. The method of claim 1, wherein said trackball comprises a wheel on a mousing device.

5. The method of claim 1, further comprising controlling said imaging system using at least one of a voice command, a foot switch, and a remote keypad.

6. The method of claim 1, further comprising pressing a button on said handheld trackball device to trigger an imaging system command.

7. A handheld trackball device for controlling an imaging system, said device comprising:
a trackball for controlling an imaging system based on motion of said trackball;
a transmitter for transmitting a command to said imaging system based on motion of said trackball; and
a housing for holding said trackball and said transmitter.

8. The device of claim 7, further comprising a button for controlling an imaging system function.

9. The device of claim 7, wherein said trackball device works with voice commands to control said imaging system.

10. The device of claim 7, wherein said trackball comprises a wheel on a mousing device.

11. The device of claim 7, wherein said device works with at least one of a voice command, a foot switch, and a remote keypad to control said imaging system.

12. The device of claim 7, wherein said handheld trackball device comprises a wireless handheld trackball device.

13. A remote mousing device for operating an imaging system, said device comprising:
a moveable portion for operating an imaging system based on motion of said moveable portion; and
a transmitter for transmitting a command to said imaging system based on said moveable portion.

14. The mousing device of claim 13, wherein said moveable portion comprises at least one of a trackball, a wheel, and a joystick.

15. The mousing device of claim 13, further comprising an additional input receptor.

16. The mousing device of claim 15, wherein said additional input receptor comprises at least one of a button, a switch, and a touch screen.

17. The mousing device of claim 13, wherein said mousing device works with at least one of a voice command, a foot switch, and a remote keypad to control said imaging system.

18. The mousing device of claim 13, wherein said mousing device comprises a wireless mousing device.

19. The mousing device of claim 13, wherein said mousing device comprises a handheld mousing device.

20. The mousing device of claim 13, further comprising a fastener for affixing said mousing device to at least one of an operator and a subject being imaged.

21. The mousing device of claim 13, wherein said mousing device is integrated with an instrument.

22. The mousing device of claim 22, wherein said instrument comprises at least one of an imaging instrument and a medical instrument.
